(19) United States
(12) Patent Application Publication
(10) Pub. No.: US 2010/0058467 A1
(43) Pub. Date: Mar. 4, 2010

(54) EFFICIENCY OF ACTIVE CONTENT FILTERING USING CACHED RULESET METADATA

(75) Inventors: Andrew Ivory, Wake Forest, NC (US); Todd E. Kaplinger, Raleigh, NC (US); Satoshi Makino, Yamato-shi (JP); Masayoshi Teraguchi, Yokohama-shi (JP); Naohiko Uramoto, Yokohama-shi (JP)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/200,608

(22) Filed: Aug. 28, 2008

(51) Int. Cl. G06F 21/00

(52) U.S. Cl. 726/22

(57) ABSTRACT

A start offset and an end offset can be identified within unfiltered content that is to be filtered. This unfiltered content can include HTML content. A corresponding start offset and an end offset of the unfiltered content can be matched against a set of content objects contained in a content cache. Each of the content objects can be associated with rule metadata. At least one filter rule can be extracted from metadata of a matching cache object. A programmatic action can be performed based upon the extracted filter rule. Computer readable output can result from the programmatic action. The output can include content that has been filtered in accordance with the extracted filter rule.

### BACKGROUND OF THE INVENTION

The present invention relates to the field of active content filtering and, more particularly, to improving the efficiency of active content filtering using cache ruleset metadata.

Active content filtering (ACF) is a key component in providing security and privacy to a broad range of computing tasks. One common problem with active content filtering is that filtering can reduce the performance of content delivery. Currently, active content filtering methodology revolves around approaching filtering from a tree data model. For example, many ACF systems analyze hypertext markup language (HTML) documents using the document object model (DOM) to determine potential harmful content. This technique suffers from performance bottlenecks due to tree traversal and frequently unnecessary data inspection. Further, this manner of ACF utilizes significant computing resources and does not scale efficiently to larger configurations.

Attempts have been made to correct this performance degradation associated with ACF processing. One approach reduces the reliance on direct content parsing through caching and focuses on structural assessments of the content. Process content is cached and new content is compared against the cache to determine if processing is necessary. While this method improves upon existing procedures, cached ACF does not represent the most optimized solution possible. Taking further advantage of the properties of cache content can provide a further gain in performance.

### BRIEF DESCRIPTION OF THE SEVERAL VIEWS OF THE DRAWINGS

FIG. 1 is a schematic diagram illustrating a system for performing active content filtering using a cache configured to store filtered content and associated rule metadata in accordance with an embodiment of the inventive arrangements disclosed herein.

FIG. 2 is a flowchart illustrating a method for optimized active content filtering using ruleset metadata caching in accordance with an embodiment of the inventive arrangements disclosed herein.

FIG. 3 is a schematic diagram illustrating a system for an active content filtering engine able to exploit cached rule metadata to improve content filtering execution in accordance with an embodiment of the inventive arrangements disclosed herein.

### DETAILED DESCRIPTION OF THE INVENTION

The present invention discloses a solution for improving the efficiency of active content filtering (ACF) using cache ruleset metadata. In the solution, unfiltered content can be processed based on one or more rules and the resulting processing can be cached for reuse. The cache can be an automation able to store states and transition data associated with applicable content filtering rules. Cached ruleset metadata can be utilized to shortcut content filtering when new content is determined to have previously been analyzed and filtered. Further, the rule scope can be used to perform partial reuse of cached content when a full match of new content against cached content is not possible. Caching ruleset metadata for reuse translates into better scalability, enhanced performance, and distribution of computing resources.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

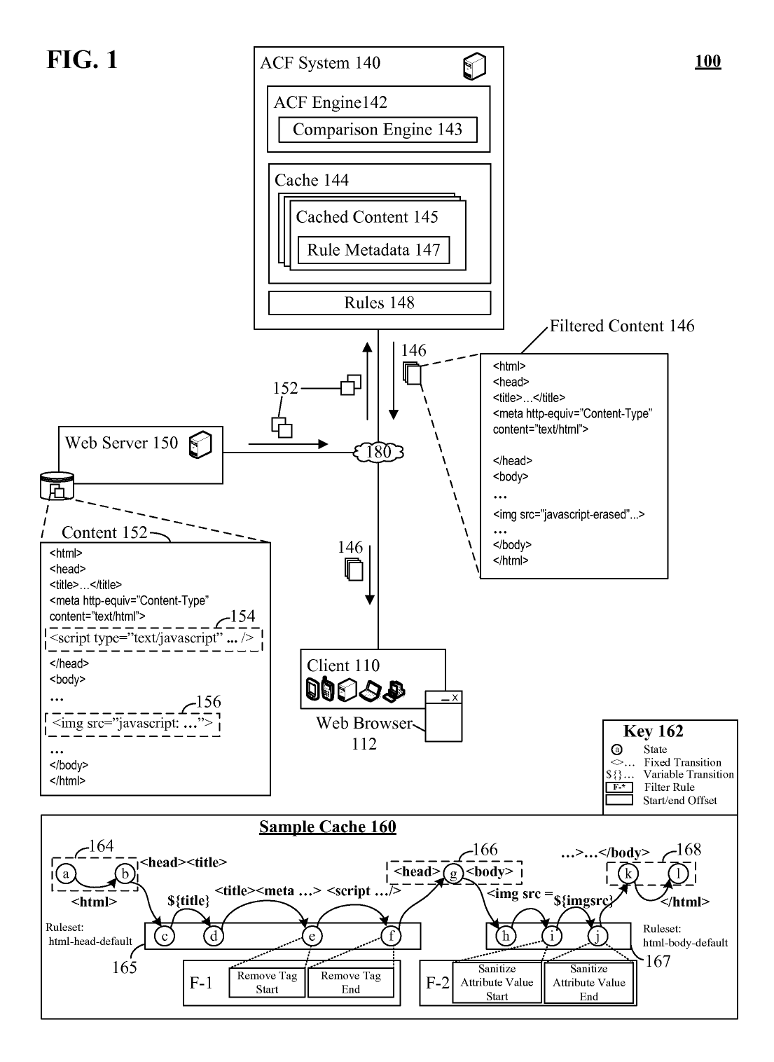

FIG. 1 is a schematic diagram illustrating a system 100 for performing active content filtering using a cache configured to store filtered content and associated rule metadata in accordance with an embodiment of the inventive arrangements disclosed herein. In system 100, active content filtering (ACF) can be performed on client 110 requested content 152. Browser 112 executing on client 110 can request content 152 from Web server 150. Server 150 can convey content 152 to client 110 via network 180. Content 152 can be processed by system 140 prior to transmission to client 110. System 140 can perform filtering on content 152 in accordance with a set of rules 147, which transform the content 152 into cached content 145. This cached content 145 can be processed to create filtered content 146 that is conveyed to client 110. The cached content 145 can be reused to respond to subsequent requests.

As used herein, content 152 can include Hypertext Markup Language (HTML), Extensible Markup Language (XML), Extensible Hypertext Markup Language (XHTML), and the like. Further, content 152 can be an aggregate (e.g., mashup) document composed of content from one or more source servers 150. Content 152 can include code 154, 156 (e.g., tags, attributes) which can be identified as unwanted content, unsafe content, potentially harmful code, and the like. This code can be removed or replaced based on rules 148 established in ACF system 140. For instance, identified JAVASCRIPT 154 code determined to be potentially harmful, can be removed using ACF system 140.

When request for content 152 occurs ACF engine 142 can perform cached and non-cached processing on the content 152 based on the contents of cache 144. When a match has not been determined, ACF engine 142 can process and filter the content 152. Content 152 is analyzed and a cache 145 entry is created for content 152. As content 152 is processed the content 145 is updated to reflect the content structure 152 and any applied rules 148. Information about rules which have been applied to content 152 can be stored associatively with cached content 145 as rule metadata 147.

Sample cache 160 illustrates one implementation for the caching process. Key 162 provides identifiers for comprehending sample cache 162. As shown by key 162, sample cache 160 shows multiple states (State-a through State-l). Either fixed transitions or variable transitions occur between the states, as shown by key 162. Two different rulesets are shown, one (e.g., ruleset 165) for the html-head-default another (e.g., ruleset 167) for the html-body-default. Different filter rules (F-1 and F-2) are applied at different states.

As shown, content 152 is processed by sample cache 160. States-a and States-b show a pre-processing 164 of an initial portion of the content 152 before the head is processed. The head is processed by ruleset 165 associated with State-c, State-d, State-e, and State-f. A transition 166 occurs between the head and body, where tag information is consumed or parsed, as shown by State-g. Ruleset 167 then processes the body of the content, which is associated with State-h, State-i, and State-j. Post-processing 168 of the content 152 associated with State-k and State-l can then occur as shown.

Should content 152 match or partially match previously processed content stored in cache 144, engine 142 can utilize the cached information 145 to bypass full content processing, which represents is an optional optimization for system 100. That is, Reuse of cached content 145 (e.g., cached HTML template) can eliminate unnecessary processing. For example, matches can be determined by comparison engine 143 which can perform a byte comparison processing of content 152 against cached content 145. Byte comparison can be executed in lieu of HTML parsing to improve filtering performance. In one embodiment, partial matches can be detected and used. For example, with a partial match, ruleset metadata 147 can be used by engine 142 to rapidly process matched content.

Drawings presented herein are for illustrative purposes only and should not be construed to limit the invention in any regard. Although presented as separate systems, system 140 can be a server 150 side component or a client side 110 component. In one embodiment, system 140 can be a proxy residing able to intercept and filter content being conveyed between server 150 and client 110. In one embodiment, system 140 can be a component within a distributable computing architecture promoting compartmentalization and distribution of computing resources. System 140 functionality can be accessible via a unified resource identifier (URI) performing request/response actions such as a Web service. Further system 140 functionality can be embodied in one or more endpoint devices such as firewalls, gateways, security checkpoint devices, and the like.

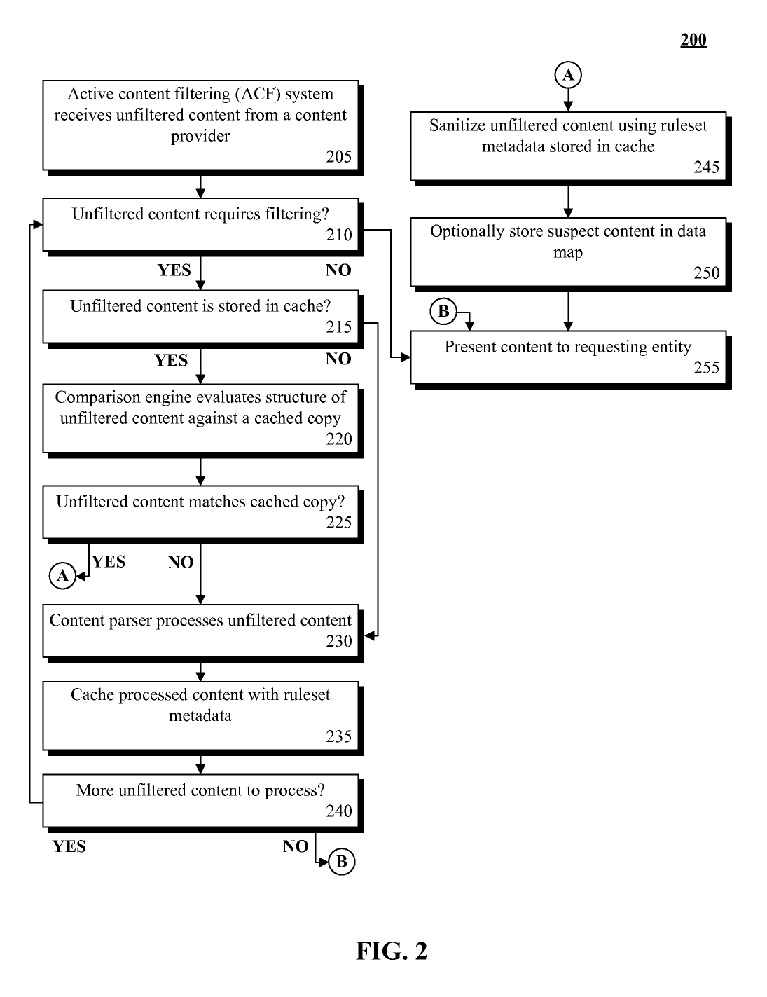

FIG. 2 is a flowchart illustrating a method 200 for optimized active content filtering using ruleset metadata caching in accordance with an embodiment of the inventive arrangements disclosed herein. Method 200 can be performed in the context of system 100. In method 200, an active content filtering (ACF) process can be enhanced through the use of a cache able to store ruleset metadata. When new unfiltered content is received, the content can be compared to cached content to determine if processing is necessary. If a match is determined, the content has previously been processed and the cached ruleset metadata can be used to save computing resources by eliminating unnecessary processing. If no match is found, the unfiltered content can be processed, such as by using a byte comparison approach. Processed content can be stored in a cache along with filtering rules which have been applied to the content.

In step 205, the ACF system receives unfiltered content from a content provider. Content from content provider can include one or more portions (e.g., aggregated content) of hypertext markup language (HTML), Extensible markup language (XML), and the like. In step 210, if the unfiltered content requires filtering the method can continue to step 215, else proceed to step 255. In step 215, if the unfiltered content is stored in the cache, the method can continue to step 220, else proceed to step 230. In step 220, the comparison engine can evaluate the structure of the unfiltered content against a cached copy. In step 225, if the unfiltered content matches a cached copy, the method can proceed to step 245, else continue to step 230. In step 230 the content parser can process the unfiltered content. In step 235, the processed content can be cached with the applicable ruleset metadata. In one embodiment, the cache can be an automation able to store the name of an applicable ruleset, the name of an applicable filter rule, and a start position and an end position within the content for which the rule can be applied.

In step 240, if there is more unfiltered content to process the method can return to step 210, else proceed to step 245. In step 245, unfiltered content can be sanitized using ruleset metadata stored in the cache. Sanitization can include the removal of suspect and/or malicious content. In step 250, removed content can be stored in a data map for composing any output template. In step 255, the filtered content can be presented to a requesting entity. Entities can include a client device, a Web server, a Web service, a messaging component, and the like.

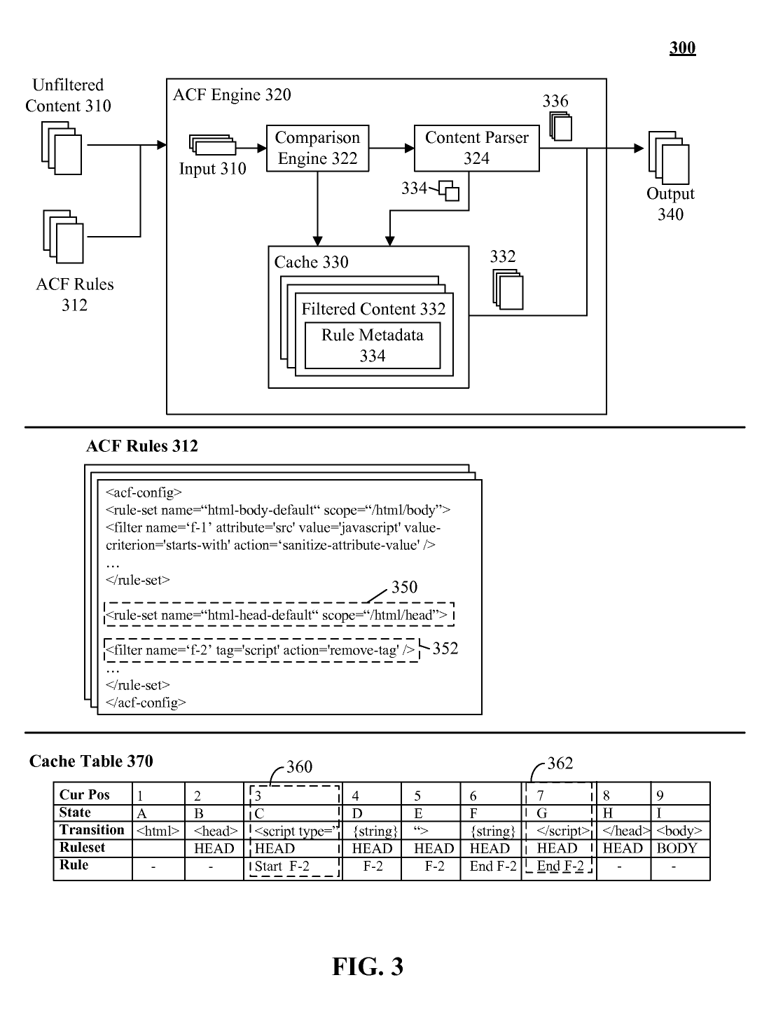

FIG. 3 is a schematic diagram illustrating system 300 for an active content filtering engine able to exploit cached rule metadata to improve content filtering execution in accordance with an embodiment of the inventive arrangements disclosed herein. System 300 can be a component present in the context of system 100. In system 300, an active content filtering engine 320 can be enhanced through the use of a cache 330 able to store rule metadata 334. Unfiltered content 310 can be processed based on ACF rules 312 which can filter unwanted and/or unsafe content such as tags and attributes. Filtered content can be produced as an output 340 which can include one or more content templates. In one embodiment, output 340 can be a Hypertext Markup Language (HTML) template able to be reused with minimal processing overhead.

As used herein, rules 312 can be associated with tags and/or attribute values within content 310. Rules 312 can be associated with an action which can be used to modify (e.g., filter) content 310. Rules 312 can be identifiable by name and/or belonging to a ruleset. Each ruleset can include a scope for which a ruleset can be active. In one embodiment, rules 312 can be maintained in an XML document.

Content 310 can be segmented into multiple inputs 310 which can allow engine 320 to process content 310 in parallel and identify partial matches within content 310. Comparison engine 322 can perform processing on inputs 310 to determine if inputs 310 have previously been processed and cached. Inputs 310 can be analyzed to determine a start and end offset for a byte sequence to be processed based on cached rule metadata 334. For instance, cache table 370 can be used to identify a start offset 360 and an end offset 362 for which a rule 352 (e.g., F-2) can be applied. Filtered content can be conveyed as content 332 to be compiled into a finalized output 340. When input 310 requires parsing, content parser 324 can execute the necessary steps. Input 310 processed by parser 324 can include filtered content and rule metadata which can be stored in cache 330. Parser 324 can identify inputs 310 which match rules 312, and the rule specified action can be performed. Filtered content 334 with applicable filtering rules 312 can be stored in cache 330 as filtered content 332 and rule metadata 334. Filtered content 336 generated from parser 324 can be used to produce can output 340.

Cache 330 can be updated as input 310 is processed and filtering rules are applied. In one embodiment cache 330 can be an automation able to store rule metadata associated with one or more states and/or transitions. A new automation can be created for each input 310 where a cached instance does not previously exist. Cached rule metadata can include ruleset metadata which can be used to identify the scope for which a set of rules can be applied. Utilizing the rule defined scope, cache 330 can be reused in a modular fashion to match portions of unfiltered content 310 (e.g., inputs 310) with cached content 332.

System 300 represents one contemplated embodiment and should not be construed to limit the invention in any regard. Cache table 330 is for illustrative purposes only, actual implementation details can vary.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for improved active content filtering comprising:
identifying a start offset and an end offset to be filtered within unfiltered content;
matching a corresponding start offset and an end offset within filtered content, wherein the correspondence is structural;
determining at least one filter rule associated with corresponding byte sequence in the matching step;
performing a programmatic action on unfiltered content specified by the associated filter rule; and
producing a computer readable output, wherein the output is at least a portion of the filtered content.

2. The method of claim 1, wherein unfiltered content is at least one of Hypertext markup language (HTML) content, Extensible markup language (XML) content, and Extensible hypertext markup language (XHTML) content.

3. The method of claim 2, wherein a filtered content object corresponding to the start offset and the end offset is stored in a filtered content cache, wherein said cache contains a plurality of distinct objects including the filtered content object, wherein each of the distinct objects is associated with a stored set of rule metadata, wherein said associated filter rule is determined by extracting data from stored rule metadata associated with the filtered content object.

4. The method of claim 1, further comprising:
processing the unfiltered content based on at least one of a plurality of filtering rules, when the determining step results in failure; and
storing the processed content in a cache wherein at least a portion of the processed content is associated with at least one filtering rule.

5. The method of claim 4, wherein the processing step results in the removal of content, wherein the removed content is stored in a data map.

6. The method of claim 4, wherein the processing step results in the substitution of unfiltered content with a different content.

7. The method of claim 1, wherein the filter rule is associated with at least one processing state.

8. The method of claim 1, wherein the output is accessible by at least one of a Unified Resource Identifier (URI) and a Web service.

9. The method of claim 1, wherein the output is an HTML template.

10. A system for improved active content filtering comprising:
an active content filtering engine configured to process unfiltered content according to at least one of a plurality of filtering rules;
a comparison engine able to compare a byte of data from unfiltered content with a byte of cached content data; and
a data store configured to cache at least a portion of filtered content and at least one associated filter rule.

11. The system of claim 10, wherein the filtering rule has a defined scope and an associated filtering action, wherein the rule is associated with at least one tag and at least one attribute within the data store.

12. The system of claim 10, wherein the data store is a cache, wherein the cache is an automation, wherein the automation stores the name of at least one filter ruleset, the name of at least one filter rule, the start position of the filter rule, and the end position of the filter rule.

13. A computer program product for improved active content filtering comprising:
a computer usable medium having computer usable program code embodied therewith, the computer usable program code comprising:
computer usable program code configured to identify a start offset and an end offset to be filtered within unfiltered content;
computer usable program code configured to match a corresponding start offset and an end offset within filtered content, wherein the correspondence is structural;
computer usable program code configured to determine at least one filter rule associated with corresponding byte sequence in the matching step;
computer usable program code configured to perform a programmatic action on unfiltered content specified by the associated filter rule; and
computer usable program code configured to produce a computer readable output, wherein the output is at least a portion of the filtered content.

14. The computer program product of claim 13, wherein unfiltered content is at least one of Hypertext markup language (HTML) content, Extensible markup language (XML) content, and Extensible hypertext markup language (XHTML) content.

15. The computer program product of claim 14, wherein a filtered content object corresponding to the start offset and the end offset is stored in a filtered content cache, wherein said cache contains a plurality of distinct objects including the filtered content object, wherein each of the distinct objects is associated with a stored set of rule metadata, wherein said associated filter rule is determined by extracting data from stored rule metadata associated with the filtered content object.

16. The computer program product of claim 13, further comprising:
computer usable program code configured to process the unfiltered content based on at least one of a plurality of filtering rules, when the determining step results in failure; and
computer usable program code configured to store the processed content in a cache wherein at least a portion of the processed content is associated with at least one filtering rule.

17. The computer program product of claim 16, wherein the processing step results in the removal of content, wherein the removed content is stored in a data map.

18. The computer program product of claim 16, wherein the processing step results in the substitution of unfiltered content with a different content.

19. The computer program product of claim 13, wherein the filter rule is associated with at least one processing state.

20. The computer program product of claim 13, wherein the output is accessible by at least one of a Unified Resource Identifier (URI) and a Web service.
